(19) United States
(12) Patent Application Publication
(10) Pub. No.: US 2025/0226593 A1
(43) Pub. Date: Jul. 10, 2025

(54) ARRAY ANTENNA STRUCTURE AND ARRAY ANTENNA MODULE

(71) Applicant: Panasonic Intellectual Property Management Co., Ltd., Osaka (JP)

(72) Inventors: NORIHITO TSUKAHARA, Kyoto (JP); MASATO MORI, Hyogo (JP); TAKAYUKI SOTOYAMA, Kanagawa (JP); NAOKI ADACHI, Kanagawa (JP)

(21) Appl. No.: 19/093,334

(22) Filed: Mar. 28, 2025

Related U.S. Application Data
(63) Continuation of application No. PCT/JP2023/033555, filed on Sep. 14, 2023.

(30) Foreign Application Priority Data
Oct. 12, 2022 (JP) 2022-164165

(51) Int. Cl. H01Q 21/06

(52) U.S. Cl. CPC H01Q 21/065

(57) ABSTRACT

Provided is an array antenna structure including m antenna structures disposed on an XY plane where m represents a number equal to or greater than 2. Each of the m antenna structures includes an antenna board, a power supply control board, and a connection member. The antenna board includes n patch antenna elements disposed at an interval P in an X direction where n represents a number equal to or greater than 2. The antenna board is disposed on the XY plane. The power supply control board has a thickness T. The power supply control board is disposed on an XZ plane. The connection member includes an insulating resin extending in the X direction and a joint electrode provided on a surface of the insulating resin. The connection member connects the antenna board and the power supply control board. The m antenna structures are each disposed in which the antenna board has a center line in the X direction that is located right or left alternately with respect to a center line of the power supply control board in the X direction.

### TECHNICAL FIELD

The present disclosure relates to an array antenna structure and an array antenna module.

### BACKGROUND ART

In recent years, commercial services by fifth generation (5G) mobile communication systems have been started, and sophistication of multimedia services is expected to be further accelerated to provide a new value as a basic technology for supporting industries and society.

The 5G is a mobile communication system that handles a high frequency band such as a millimeter wave exceeding 10 GHz, and includes a transmitting and receiving antenna for which a patch antenna (microstrip antenna) that is a type of planar antenna is generally used, the patch antenna including a dielectric board, and a radiation element and a ground conductor plate wired on both surfaces of the dielectric board, as components.

To obtain desired radiation directivity (radiation pattern), the patch antenna is often used as a multi-element array antenna in which a plurality of patch antennas is regularly arranged in a linear manner, a planar manner, or the like.

The patch antenna used as the multi-element array antenna enables large-capacity communication.

The patch antenna or the like includes an antenna element that is connected to various signal processing circuits or power feeding circuits to constitute an antenna structure (i.e., an antenna module).

Then, the antenna structure is housed in a housing such as a case or a cover, and is practically used as an antenna unit for communication.

For example, PTL 1 discloses an antenna structure and an antenna unit that each include an antenna element part, and a circuit part that amplifies an electric signal converted by the antenna element part.

The antenna element part and the circuit part are formed separately from each other to constitute an antenna unit structure in which they are connected to each other by a cable, and housed in an external case while being juxtaposed to each other.

In recent years, the antenna unit is strongly required to be downsized because increase in size limits a place where the antenna unit is installed.

Unfortunately, the structure of the antenna structure of PTL 1 in which the antenna element part and the circuit part are juxtaposed to each other requires securing an area for providing the antenna element unit and the circuit unit side by side in a planar direction, and thus downsizing of the antenna structure is difficult.

For this reason, PTL 2 discloses an antenna structure to achieve downsizing of the antenna unit, for example, the antenna structure including: an antenna element part including a ground conductor and an antenna pattern formed on an upper surface of the ground conductor with a first dielectric board interposed therebetween; and a circuit part including a circuit pattern formed on a lower surface of the ground conductor with a second dielectric board interposed therebetween and a circuit component mounted.

### CITATION LIST

### Patent Literature

PTL 1: Unexamined Japanese Utility Model Publication No. H06-041220
PTL 2: Unexamined Japanese Patent Publication No. H06-152237

### SUMMARY OF THE INVENTION

An array antenna structure according to an aspect of the present disclosure includes m antenna structures disposed on an XY plane where m represents a number equal to or greater than 2. Each of the m antenna structures includes an antenna board, a power supply control board, and a connection member. The antenna board includes n patch antenna elements disposed at an interval P in an X direction where n represents a number equal to or greater than 2. The antenna board is disposed on the XY plane. The power supply control board has a thickness T. The power supply control board is disposed on an XZ plane. The connection member includes an insulating resin extending in the X direction and a joint electrode provided on a surface of the insulating resin. The connection member connects the antenna board and the power supply control board. The m antenna structures are each disposed in which the antenna board has a center line in the X direction that is located right or left alternately with respect to a center line of the power supply control board in the X direction.

### BRIEF DESCRIPTION OF THE DRAWINGS

FIG. 1A is a schematic diagram illustrating an example of an antenna structure according to a first exemplary embodiment.

FIG. 1B is a schematic diagram of an example of the antenna structure according to the first exemplary embodiment as viewed from front to back in an X direction.

FIG. 1C is a schematic diagram of an example of the antenna structure according to the first exemplary embodiment as viewed from right to left in a Y direction.

FIG. 2A is a schematic diagram of an example of the antenna structure according to the first exemplary embodiment as viewed from right to left in the Y direction.

FIG. 2B is a schematic diagram of another example of the antenna structure according to the first exemplary embodiment as viewed from right to left in the Y direction.

FIG. 3 is a schematic diagram illustrating still another example of the antenna structure according to the first exemplary embodiment.

FIG. 4A is a schematic diagram illustrating an example of an array antenna structure according to the first exemplary embodiment.

FIG. 4B is a schematic diagram of an example of the array antenna structure according to the first exemplary embodiment as viewed from an upper side toward a lower side in a Z direction.

FIG. 5 is a schematic diagram of an example of an array antenna module according to the first exemplary embodiment as viewed from the lower side toward the upper side in the Z direction.

### DESCRIPTION OF EMBODIMENT

The structure of the antenna structure shown in PTL 2 has a problem that a small antenna structure having a mounting area equal to or less than a mounting area of a circuit component is difficult in being fabricated because even when an antenna element is downsized, a size of the entire antenna structure is determined by a mounting area of the circuit component mounted on a surface of the dielectric board, the surface being opposite to the antenna element part.

The structure also has a problem that even when a plurality of antenna elements is disposed side by side to form an array antenna structure, an array antenna structure with a plurality of small antenna elements disposed side by side at narrow intervals is difficult in being fabricated because an interval at which antenna elements are disposed side by side is restricted by the mounting area of the circuit component mounted on the surface of the dielectric board, the surface being opposite to the antenna element part.

Array antenna structure is usually formed by disposing antenna elements side by side at intervals that are each a half wavelength of a communication frequency, so that when communication with a high frequency of 39 GHz is required, for example, a half wavelength of the wavelength is a very small value of 2.56 mm. Thus, the structure of the antenna structure disclosed in PTL 2 causes a plurality of antenna elements to be more difficult in being disposed at intervals that are each the half wavelength of the wavelength.

As described above, it is an object of the present disclosure to provide a small array antenna structure and a small array antenna module each of which is compatible with high frequency communication and is not restricted in size by a size or a mounting area of a circuit component constituting a signal circuit or a power supply circuit.

Various aspects of the present disclosure will be described below before exemplary embodiments of the present disclosure are described in detail with reference to the drawings.

An array antenna structure according to a first aspect includes m antenna structures disposed on an XY plane where m represents a number equal to or greater than 2. Each of the m antenna structures includes an antenna board including n patch antenna elements disposed at an interval P in an X direction where n represents a number equal to or greater than 2 and being disposed on the XY plane, a power supply control board having a thickness T disposed on an XZ plane, and a connection member including an insulating resin extending in the X direction and a joint electrode provided on a surface of the insulating resin, the connection member connecting the antenna board and the power supply control board. The m antenna structures are each disposed in which the antenna board has a center line in the X direction that is located right or left alternately with respect to a center line of the power supply control board in the X direction.

An array antenna structure according to a second aspect in the first aspect is configured such that the patch antenna elements of each of the two adjacent array antenna structures are disposed at an interval P in a Y direction.

An array antenna structure according to a third aspect in the array antenna structure according to the first or second aspect is configured such that the interval P is a half wavelength of a communication frequency.

An array antenna module according to a fourth aspect includes the array antenna structure according to any one of the first and second aspects, in which the power supply control board includes an XZ region without overlapping the antenna board in the X direction, the XZ region being equipped with an electronic component having a height less than or equal to a height I, and a relational expression of “I<2P−T” is satisfied.

An array antenna module according to a fifth aspect in the fourth aspect is configured such that the power supply control board includes an XZ region overlapping the antenna board of in the X direction of the array antenna structure, the XZ region being equipped with an electronic component having a height less than or equal to a height H, and a relational expression of “H<P−T” is satisfied.

An array antenna module according to a sixth aspect in the fourth aspect is configured such that the interval P is a half wavelength of a communication frequency.

An array antenna module according to a seventh aspect in the fifth aspect is a half wavelength of a communication frequency.

The array antenna structure and the array antenna module according to an aspect of the present disclosure enable providing an array antenna structure and an array antenna module that are small in size and are not restricted in size by a size or a mounting area of a circuit component constituting a signal circuit or a power supply circuit.

Hereinafter, an array antenna structure and an array antenna module according to exemplary embodiments of the present disclosure will be described with reference to the drawings.

The drawings each show substantially identical members that are denoted by respective identical reference marks.

### Exemplary Embodiment

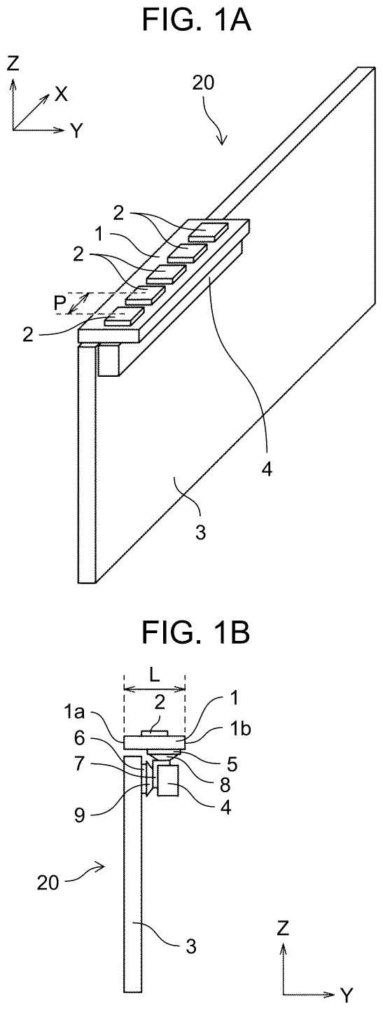

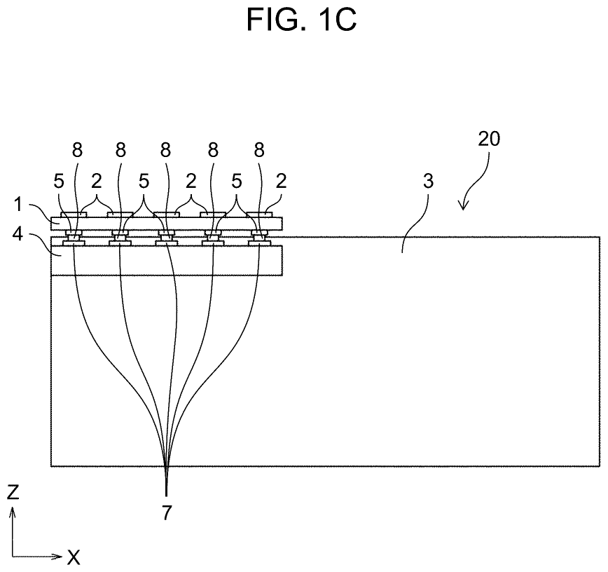

FIGS. 1A to 1C are each a schematic diagram illustrating an example of antenna structure 20 according to a first exemplary embodiment. Antenna structure 20 is configured such that antenna board 1 and power supply control board 3 are connected by connection member 4. Three directions of XYZ are disposed orthogonal to each other.

In FIGS. 1A to 1C, antenna board 1 is disposed parallel to the XY plane. Patch antenna elements 2 are formed parallel to each other in the X direction at equal intervals P on a surface of antenna board 1.

Each of intervals P between corresponding patch antenna elements 2 is determined by a communication frequency of a device, and has a value of ½ of a wavelength. The first exemplary embodiment uses a communication frequency of 39 GHz, for example, so that the interval P is 2.56 mm that is a half wavelength of the communication frequency.

The first exemplary embodiment uses a multilayer board material “MEGTRON 7” manufactured by Panasonic Corporation as a base material to form antenna board 1 with a width of 3 mm, a length of 20 mm, and a thickness of 0.8 mm, for example.

Five patch antenna elements 2 each formed in a size of “2 mm×2 mm” using copper foil with a thickness of 18 m are disposed at equal intervals P, for example.

The number of patch antenna elements 2 may be an optimum number (n) depending on application of the antenna. Then, “n” is an integer more than zero.

The material of antenna board 1 is not limited to “MEGTRON 7”, and may be another glass epoxy material or ceramic material.

Antenna board 1 is provided with feeding electrode 5 on its surface opposite to its surface provided with patch antenna elements 2.

Connection member 4 made of an insulating resin extends in the X direction and is disposed parallel to the XY plane. Connection member 4 is provided on its surface with joint electrode 7.

Connection member 4 has a width of 1.0 mm in the Y direction, a height of 2.0 mm in the Z direction, and a length of 20 mm in the X direction, for example.

Although a liquid crystal polymer (LCP) having a dielectric constant of 4.3 and a dielectric loss tangent of 0.015 is used as a material of the insulating resin of the connection member 4, for example, the material is not limited thereto, and may be PPA, ABS, PEEK, or PC.

Although joint electrode 7 including 10 m thick Cu, 0.2 m thick Ni, and 0.05 m thick Au is formed by a plating method, for example, it may be formed by printing, dispensing coating, or the like of a conductive resin, or other methods.

Joint electrode 7 forms first junction 8 that is metal-joined to feeding electrode 5 of antenna board 1. The first exemplary embodiment uses solder having a composition of Sn-3.0Ag-0.5Cu as a material for metal-joining joint electrode 7 and feeding electrode 5, for example.

Joint material is not limited to solder, and other joint materials such as a conductive paste of Ag or Cu may be used.

Power supply control board 3 has a board thickness T and is disposed parallel to the XZ plane. Power supply control board 3 is provided on its surface with power supply electrode 6 that forms second junction 9 metal-joined to joint electrode 7 of connection member 4.

Although the first exemplary embodiment uses Sn—Bi solder to join power supply electrode 6 to joint electrode 7, the present invention is not limited thereto.

First junction 8 and second junction 9 may have an integrated shape depending on a molten state of solder or the like that is a material for metal-joining.

Although not illustrated, power supply control board 3 is equipped with circuit components constituting a signal circuit or a power supply circuit. The first exemplary embodiment includes power supply control board 3 with a size of 50 mm in length in the X direction, 30 mm in length in the Z direction, and 1.6 mm in thickness in the X direction, for example.

The configuration described above forms antenna structure 20 in which antenna board 1 disposed parallel to the XY plane and power supply control board 3 disposed parallel to the XZ plane are electrically connected using connection member 4.

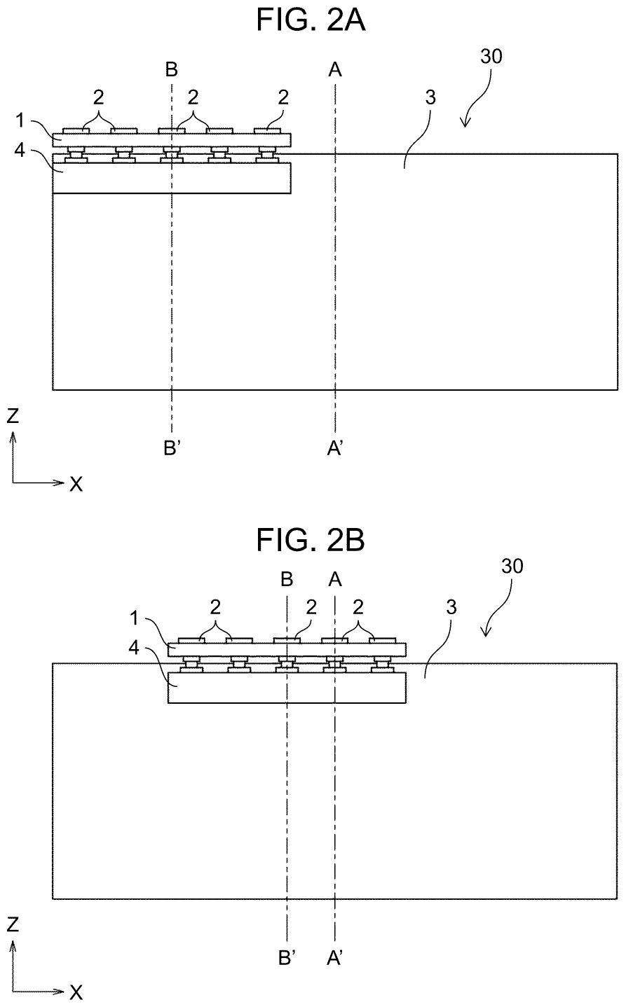

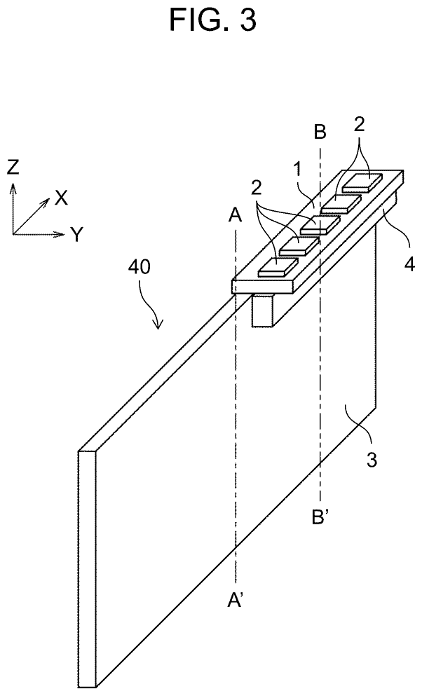

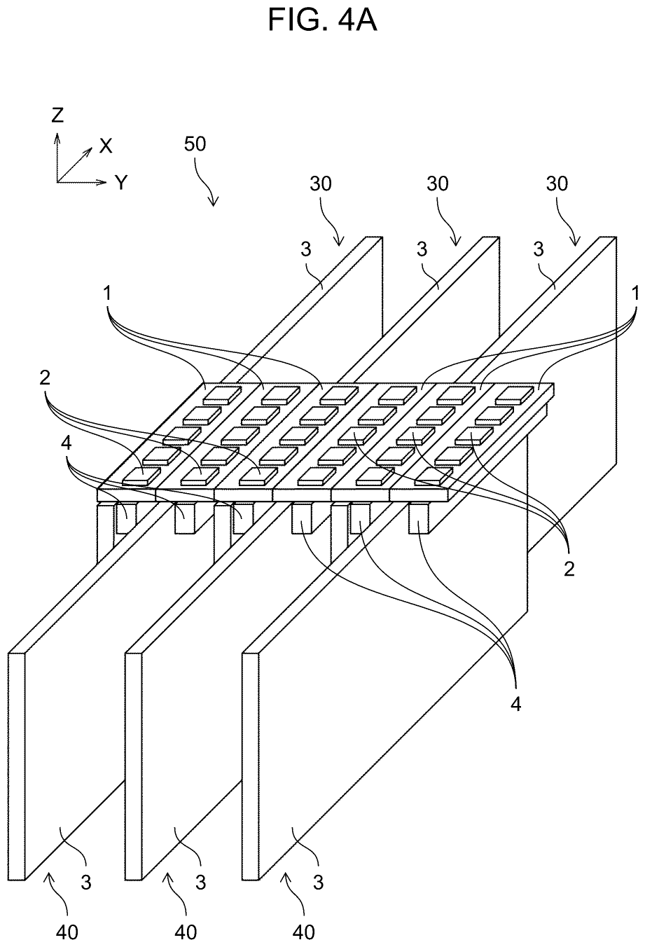

Next, a more specific configuration of antenna structure 20 according to the first exemplary embodiment will be described with reference to FIGS. 2A to 2B, and 3.

As illustrated in FIG. 2A, antenna board 1 is disposed with center line B-B′ in the X direction that is located left from center line A-A′ in the X direction of power supply control board 3, thereby constituting antenna structure 30. That is, center line B-B′ in the X direction located left from center line A-A′ in the X direction of power supply control board 3 means that center line B-B′ may be displaced by even a little, or 1 mm, for example.

Although FIG. 2A illustrates an example of antenna structure 30 configured such that antenna board 1, power supply control board 3, and connection member 4 have respective left ends in the X direction that are aligned, antenna structure 30 is not required to have a configuration in which the left ends in the X direction of the respective members are aligned as long as center line B-B′ of antenna board 1 in the X direction is located left from center line A-A′ of power supply control board 3 in the X direction as illustrated in FIG. 2B.

FIG. 3 is a schematic diagram of antenna structure 40 having a configuration in which center line B-B′ of antenna board 1 in the X direction is located right from center line A-A′ of power supply control board 3 in the X direction.

Center line B-B′ in the X direction of antenna board 1 is only required to be located right from center line A-A′ in the X direction of power supply control board 3 even in antenna structure 40, so that a configuration illustrated in the schematic diagram of FIG. 3 is not necessarily required, the configuration including antenna board 1, power supply control board 3, and connection member 4 that have respective right ends aligned in the X direction. That is, center line B-B′ in the X direction located right from center line A-A′ in the X direction of power supply control board 3 means that center line B-B′ may be displaced by even a little, or 1 mm, for example.

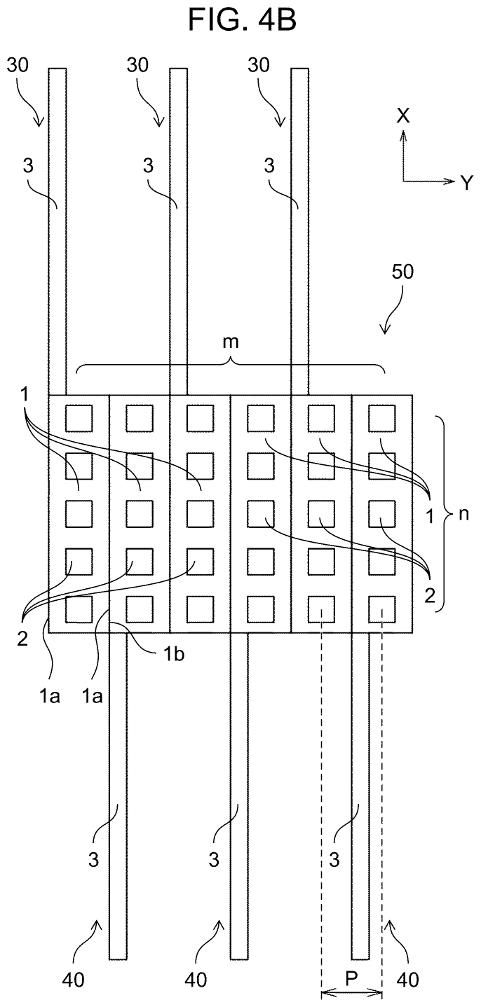

Next, array antenna structure 50 of the first exemplary embodiment will be described with reference to FIGS. 4A and 4B.

As illustrated in FIGS. 4A and 4B, array antenna structure 50 of the first exemplary embodiment includes m antenna structures 30 and m antenna structures 40 that are alternately disposed in the Y direction. Then, “m” is an integer equal to or more than two. Antenna structure 30 includes antenna board 1 with center line B-B′ in the X direction that is located left from center line A-A′ in the X direction of power supply control board 3. Antenna structure 40 includes antenna board 1 with center line B-B′ in the X direction that is located right from center line A-A′ in the X direction of power supply control board 3.

Antenna structure 30 includes antenna board 1 with a first orthogonal end surface (an XZ plane corresponding to right end surface 1b in FIG. 1B) in the Y direction. Antenna structure 40 includes antenna board 1 with a second orthogonal end surface (an XZ plane corresponding to left end surface 1a in FIG. 1B) in the Y direction. Array antenna structure 50 includes antenna structure 30 with a first orthogonal end surface that faces and is in contact with the second orthogonal end surface of antenna structure 40.

When each of antenna structures 30, 40 is viewed from a direction as in FIG. 1B, power supply control board 3 and connection member 4 are disposed within width dimension L of antenna board 1 in the Y direction to be prevented from protruding from width dimension L in the Y direction. For example, FIG. 1B shows that the second orthogonal end surface (the XZ plane corresponding to left end surface 1a in FIG. 1B) of antenna board 1 in the Y direction and the XZ plane of the outside of power supply control board 3 are flush with each other, and antenna board 1 and power supply control board 3 are disposed in an L shape. Antenna boards 1 of antenna structures 30, 40 adjacent to each other may be in contact with each other or may be separated without being in contact with each other.

Although the first exemplary embodiment shows an example in which antenna structures 30 and antenna structures 40 are alternately disposed in number of six, the structures may be manufactured in an optimum number (m) depending on application of the antenna. When n patch antenna elements 2 are formed on antenna board 1, n×m patch antenna elements 2 constitute array antenna structure 50.

Antenna structure 30 and antenna structure 40 according to the first exemplary embodiment are alternately disposed in a positional relationship in which patch antenna elements 2 of each structure are disposed at intervals P in the Y direction that are each 2.56 mm being a half wavelength of a communication frequency of 39 GHz.

As a result, array antenna structure 50 small in size is formed in which n×m patch antenna elements 2 are disposed side by side in a matrix at equal intervals that are each a half wavelength of a communication frequency.

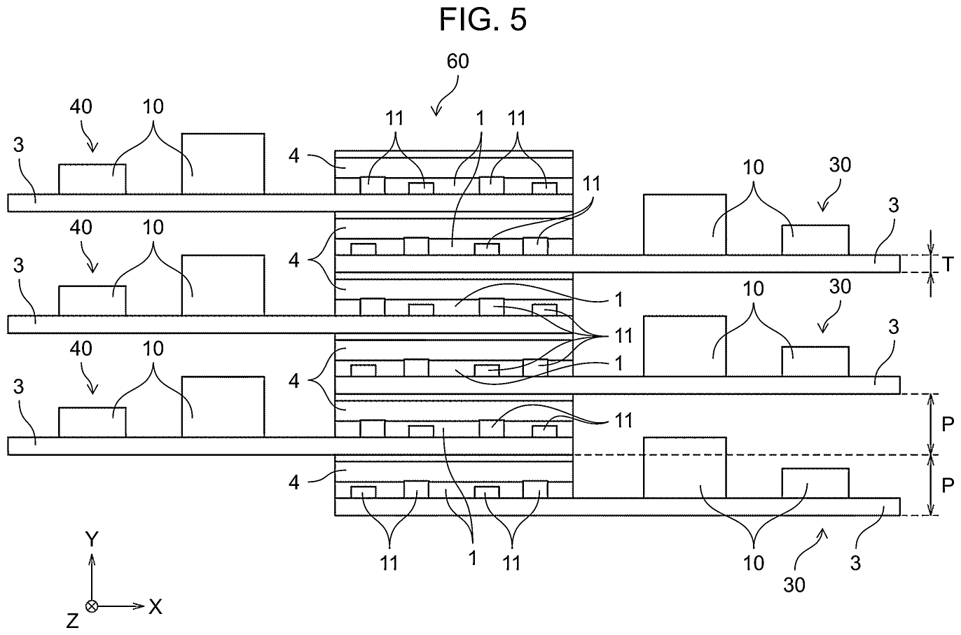

Next, an array antenna module according to the first exemplary embodiment will be described with reference to FIG. 5.

FIG. 5 is a schematic diagram of array antenna module 60 according to the first exemplary embodiment as viewed from the Z direction.

An array antenna structure in which antenna structure 30 and antenna structure 40 are disposed side by side at equal intervals P in the Y direction includes electronic components 10 each having a height equal to or less than height I, the height satisfying a relational expression of “I<2P−T”, and components 10 being mounted on a XZ region of power supply control board 3 of each of antenna structure 30 and antenna structure 40, the XZ region not overlapping antenna board 1.

Power supply control board 3 includes an XZ region overlapping antenna board 1 in the X direction of the array antenna structure, the XZ region being equipped with electronic components 11 each having a height equal to or less than height H, the height satisfying a relational expression of “H<P−T”.

The array antenna module of the first exemplary embodiment uses a communication frequency aimed at 39 GHz, for example, so that interval P between antenna structure 30 and antenna structure 40 is 2.56 mm that is a half wavelength of the wavelength.

However, components required to be mounted on power supply control board 3 to constitute antenna structure 30 and antenna structure 40 include a tall component having a thickness exceeding 2.56 mm, such as a high-frequency control IC or a power supply control IC.

It is physically impossible to dispose such a component on an XZ region of power supply control board 3, the XZ region overlapping antenna board 1 and having a gap between antenna structure 30 and antenna structure 40, the gap being only “P−T”.

The array antenna module according to the first exemplary embodiment includes antenna structure 30 and antenna structure 40 that are alternately disposed side by side. The array antenna module has spaces generated by center lines B-B′ of antenna boards 1 in the X direction being alternately located right and left from center lines A-A′ of corresponding power supply control boards 3 in the X direction. On an XZ region of power supply control board 3, the XZ region not overlapping antenna board 1, a gap between the antenna structures 30, 40 is “2P−T”, thereby giving a margin of mountable component height. Thus, antenna structures 30 and antenna structures 40 on each of which all necessary components are mounted on power supply control board 3 can be disposed side by side at equal intervals P.

As a result, array antenna module 50 small in size can be fabricated in which n×m patch antenna elements 2 are disposed side by side in a matrix at equal intervals that are each a half wavelength of a communication frequency.

Using the structure according to the first exemplary embodiment of the present disclosure enables providing array antenna module 60 that is small in size and compatible with high frequency communication, and that has a structure in which patch antenna elements 2 are disposed side by side in a matrix at equal intervals that are each a half wavelength of a communication frequency even when a component having a thickness equal to or more than the half wavelength of the communication frequency is mounted on power supply control board 3.

The array antenna structure and the array antenna module according to the first exemplary embodiment of the present disclosure enable providing an array antenna structure and an array antenna module that are small in size and are not restricted in size by a size or a mounting area of a circuit component constituting a signal circuit or a power supply circuit.

That is, a direction in which antenna elements 2 are disposed side by side at intervals, i.e., a thickness direction or an array direction of antenna structures 20,30, 40, can be set as a direction intersecting with a direction affected by size or a mounting area of a circuit component, such as an orthogonal direction, to eliminate influence of the mounting area or the like.

Specifically, the circuit component has the mounting area that is along the XZ plane and is orthogonal to the Y direction being the thickness direction of the antenna structure 20, 30, 40, and the thickness direction is not affected by the mounting area or the like. Thus, antenna structure 20, 30, 40 that is small in size and has a size equal to or less than the mounting area of the circuit component can be fabricated.

The mounting area of the circuit component is along the XZ plane and is orthogonal to the Y direction being the array direction of antenna structures 20, 30, 40. Thus, the array direction is not affected by the mounting area or the like. Even when a plurality of antenna elements 2 is disposed side by side to form array antenna structure 20, 30, 40, an interval at which antenna elements 2 are disposed side by side is not limited by the mounting area of the circuit component or the like. As a result, array antenna structure 20, 30, 40 can be fabricated in which a plurality of small antenna elements 2 is disposed side by side at narrow intervals.

Even when high frequency communication such as 39 GHz is required for a configuration in which a plurality of antenna elements is disposed side by side at intervals that are each a half wavelength of a communication frequency, for example, i.e., even when the half wavelength of the wavelength is a very small value, the plurality of antenna elements can be disposed side by side at the intervals that are each the half wavelength of the wavelength.

Any appropriate combination of the various exemplary embodiments or modifications described above enables effects of the respective exemplary embodiments or modifications to be achieved. Additionally, combinations of exemplary embodiments, combinations of examples, or combinations of exemplary embodiments and examples are possible, and combinations of features in different exemplary embodiments or examples are also possible.

### INDUSTRIAL APPLICABILITY

The array antenna structure and the array antenna module according to the aspect of the present disclosure enable providing an array antenna structure and an array antenna module that are small in size and compatible with high frequency communication without being restricted in size by a size or a mounting area of a circuit component constituting a signal circuit or a power supply circuit.

### REFERENCE MARKS IN THE DRAWINGS

1 antenna board
2 patch antenna element
3 power supply control board
4 connection member
5 feeding electrode
6 power supply electrode
7 joint electrode
8 first junction
9 second junction
10 electronic component
11 electronic component
20 antenna structure
30 antenna structure
40 antenna structure
50 array antenna structure
60 array antenna module

1. An array antenna structure comprising:
m antenna structures disposed on an XY plane where m represents a number equal to or greater than 2,
each of the m antenna structures including:
an antenna board including n patch antenna elements disposed at an interval P in an X direction where n represents a number equal to or greater than 2, the antenna board being disposed on the XY plane;
a power supply control board having a thickness T, the power supply control board being disposed on an XZ plane; and
a connection member including an insulating resin extending in the X direction and a joint electrode provided on a surface of the insulating resin, the connection member connecting the antenna board and the power supply control board,
wherein the m antenna structures are each disposed in which the antenna board has a center line in the X direction that is located right or left alternately with respect to a center line of the power supply control board in the X direction.

2. The array antenna structure according to claim 1, wherein two adjacent patch antenna elements each included in a corresponding one of two adjacent antenna structures among the m antenna structures are disposed at an interval P in a Y direction.

3. The array antenna structure according to claim 1, wherein the interval P is a half wavelength of a communication frequency.

4. An array antenna module comprising the array antenna structure according to claim 1,
wherein the power supply control board includes an XZ region without overlapping the antenna board in the X direction, the XZ region being equipped with an electronic component having a height less than or equal to a height I, and a relational expression of “I<2P−T” is satisfied.

5. The array antenna module according to claim 4, wherein the power supply control board includes an XZ region overlapping the antenna board in the X direction of the array antenna structure, the XZ region being equipped with an electronic component having a height less than or equal to a height H, and a relational expression of “H<P−T” is satisfied.

6. The array antenna module according to claim 4, wherein the interval P is a half wavelength of a communication frequency.

7. The array antenna module according to claim 5, wherein the interval P is a half wavelength of a communication frequency.
